(19) United States
(12) Patent Application Publication
(10) Pub. No.: US 2018/0060014 A1
(43) Pub. Date: Mar. 1, 2018

(54) DISPLAY APPARATUS, VIDEO WALL SYSTEM HAVING THE SAME AND CONTROL METHOD THEREOF

(71) Applicant: SAMSUNG ELECTRONICS CO., LTD., Suwon-si (KR)

(72) Inventors: Ho-yong SON, Hwaseong-si (KR); Young-chan KIM, Uiwang-si (KR)

(21) Appl. No.: 15/685,098

(22) Filed: Aug. 24, 2017

(30) Foreign Application Priority Data
Aug. 25, 2016 (KR) 10-2016-0108647

(51) Int. Cl. G06F 3/14; G09G 3/20

(52) U.S. Cl. CPC G06F 3/1446; G09G 3/2092; G06F 3/1431; G09G 2360/04; G09G 2300/026; G09G 2356/00; G09G 2354/00

(57) ABSTRACT

A video wall system for displaying a video wall image is provided. The video wall system includes a plurality of display apparatuses configured to display a video wall image, and each of the plurality of display apparatuses includes a signal processor, a display and a controller. The signal processor is configured to process an image signal of a video wall image. The display scans in one of a first scanning direction and a second scanning direction opposite the first scanning direction based on the processed image signal to display an individual image split from the video wall image. The controller controls the display to scan in one of the first scanning direction and the second scanning direction determined based on a scanning direction of an adjacent other display apparatus. With this, the video wall system may display the video wall image without generating steps caused by differences in screen playing speed between adjacent display apparatuses.

### CROSS-REFERENCE TO RELATED APPLICATION

This application is based on and claims priority under 35 U.S.C. § 119 to Korean Patent Application No. 10-2016-0108647, filed on Aug. 25, 2016 in the Korean Intellectual Property Office, the disclosure of which is incorporated by reference herein in its entirety.

### BACKGROUND

### Field

The present disclosure relates generally to a display apparatus, a video wall system having the same and a control method thereof, and for example to a display apparatus for scanning a screen in a predetermined direction to display an image, a video wall system having the same and a control method thereof.

### Description of Related Art

Collectively, all display products for posting public information are referred to as a digital information display (DID). In recent, a DID type advertising, which provides advertisements and promotional videos of products or enterprises for unspecified individuals via a large-sized DID system installed in a public place with a large transient population, is increasing. As an example of the DID system, a large format display (LFD) has a size larger than a general display, and is mainly used for reproducing advertisement contents. The LFD outputs external inputs or television (TV) signals from a personal computer (PC), a high definition multimedia interface (HDMI), a digital visual interface (DVI), a display panel (DP), an audio/video (AV), component etc. The LFT may be implemented as a standalone type using a single display apparatus, but also as a video wall type including a plurality of display apparatuses connected with one another. In the video wall type LFD including the plurality of display apparatuses, each display apparatus splits the received video wall image with respect to a region corresponding thereto to generate an individual image therefor and displays the generated individual image.

To display the generated individual image on a screen, each display apparatus performs a scanning, which combines signals to make an image surface. Since a vertical scanning is sequentially performed with respect to the whole of one screen, a difference in time in which a frame is displayed may occur between one end (e.g., a top portion) of the screen from which the vertical scanning begins and the other end (e.g., a bottom portion) of the screen to which the vertical scanning is completed. In other words, when an n-th frame is scanned onto the one end of the screen, an n-1-th frame may be still displayed on the other end of the screen. Accordingly, at meeting portions between the adjacent two display apparatuses, one display apparatus may display the n-th frame and at the same time, the other display apparatus may display the n-1-th frame. As a result, a problem may occur in that a user feels like as if any steps or bumps are generated in the video wall screen. Hereinafter, a scanning direction may refer, for example, to a direction of the vertical scanning.

### SUMMARY

Example embodiments address at least the above problems and/or disadvantages and other disadvantages not described above.

The example embodiments may provide a display apparatus, a video wall system having the same and a control method thereof, which can display a video wall image without steps generating due to a difference in time in which a frame is displayed on meeting portions between adjacent display apparatuses in a video wall screen during a vertical scanning.

According to an aspect of an example embodiment, a video wall system is provided, including
a plurality of display apparatuses configured to display a video wall image, each of the plurality of display apparatuses including a signal processor configured to process an image signal of a video wall image, a display configured to scan in one of a first scanning direction and a second scanning direction opposite the first scanning direction based on the processed image signal to display an individual image split from the video wall image; and a controller configured to control the display to scan in one of the first scanning direction and the second scanning direction determined based on a scanning direction of an adjacent other display apparatus. Accordingly, the video wall system may display the video wall image without generating steps due to a difference in time in which a frame is displayed on meeting portions between the adjacent display apparatuses in the video wall screen during the vertical scanning.

The controller may be configured to determine the one of the first scanning direction and the second scanning direction to be in an opposite direction to a scanning direction of an adjoining other display apparatus adjoining in scanning direction. Thus, the steps, which are generated between display apparatuses adjoining in scanning direction in the video wall screen, may be improved.

The controller may be configured to determine an orientation direction of a screen based on a rotation direction in which the display apparatus is installed. Thus, the display apparatus may detect a rotation state and change a direction of the screen on its own, thereby improving user's convenience.

The controller may be configured to control the display to scan in one of the first scanning direction and the second scanning direction determined based on a location on which the display apparatus is installed. Thus, the display apparatus may determine the one scanning direction based on the installed location, thereby improving the steps, which are generated between adjacent display apparatuses in the video wall screen.

The controller may be configured to control the display to scan in one of the first scanning direction and the second scanning direction determined further based on a direction where the display apparatus is installed. Thus, the display apparatus may more precisely determine the one scanning direction to be in a direction opposite to a scanning direction of adjacent display apparatus, taking account of the installed direction as well as the installed location.

The system may further include a storage (memory) configured to store one of the first scanning direction and the second scanning direction selected based on the scanning direction of the adjacent other display apparatus, and the controller may be configured to control the display to scan based on the stored one scanning direction. Thus, the display apparatus may scan based on the stored one scanning direction without requiring a determination of the scanning direction, thereby allowing the display apparatus to more efficiently perform the scanning.

The controller may be configured to store in the storage, one of the first scanning direction and the second scanning direction received from an external apparatus. Thus, the display apparatus may store the scanning direction in advance based on information received from the external.

The controller may be configured to store in the storage, one of the first scanning direction and the second scanning direction selected by a user. Thus, the display apparatus may store the scanning direction that the user wants, thereby improving user's convenience.

The controller may be configured to control the display to scan in one of the first scanning direction and the second scanning direction selected by a user. Thus, the display apparatus may determine the scanning direction based on a user's intention, thereby improving user's convenience.

The controller may be configured to display on the display, a user interface (UI) for selecting one of the first scanning direction and the second scanning direction. Thus, the display apparatus may receive a user selection via the UI to perform the scanning or store the scanning direction in advance, based on the received user selection, thereby improving user's convenience.

According to an example aspect of another example embodiment, a control method of a video wall system including a plurality of display apparatuses configured to display a video wall image is provided, the method including: processing, by each of the plurality of display apparatuses, an image signal of a video wall image; scanning, by each of the plurality of display apparatuses, in one of a first scanning direction and a second scanning direction opposite the first scanning direction based on the processed image signal to display an individual image split from the video wall image, the scanning including scanning in one of the first scanning direction and the second scanning direction determined based on a scanning direction of an adjacent other display apparatus. Accordingly, the video wall system may display the video wall image without generating steps due to a difference in time in which a frame is displayed on meeting portions between the adjacent display apparatuses in the video wall screen during the vertical scanning.

The scanning may include determining the one of the first scanning direction and the second scanning direction to be in an opposite direction to a scanning direction of the other display apparatus adjoining in scanning direction. Thus, the steps, which are generated between display apparatuses adjoining in scanning direction in the video wall screen, may be improved.

The individual image may be displayed to have an orientation direction of screen determined based on a rotation direction where the display apparatus is installed. Thus, the display apparatus may detect a rotation state and change a direction of screen on its own, thereby improving user's convenience.

The scanning may include scanning in one of the first scanning direction and the second scanning direction determined based on a location at which the display apparatus is installed. Thus, the display apparatus may determine the one of the first scanning direction and the second scanning direction based on the installed location, thereby improving the steps, which are generated between adjacent display apparatuses in the video wall screen.

The scanning may include scanning in one of the first scanning direction and the second scanning direction determined further based on a direction where the display apparatus is installed. Thus, the display apparatus may more precisely determine the one scanning direction to be in a direction opposite to a scanning direction of an adjacent display apparatus, taking account of the installed direction as well as the installed location.

The scanning may include storing one of the first scanning direction and the second scanning direction selected based on the scanning direction of the adjacent other display apparatus, and scanning based on the stored one scanning direction. Thus, the display apparatus may scan based on the stored one scanning direction without requiring determination of the scanning direction, thereby allowing the display apparatus to more efficiently perform the scanning.

The storing may include storing one of the first scanning direction and the second scanning direction received from an external apparatus. Thus, the display apparatus may store the scanning direction in advance based on information received from the external.

The storing may include storing one of the first scanning direction and the second scanning direction selected by a user. Thus, the display apparatus may store the scanning direction that the user wants, thereby improving user's convenience.

The scanning may include scanning in one of the first scanning direction and the second scanning direction selected by a user. Thus, the display apparatus may determine the scanning direction based on a user's intention, thereby improving user's convenience.

The control method may further include displaying a user interface (UI) for selecting one of the first scanning direction and the second scanning direction. Thus, the display apparatus may receive a user selection via the UI to perform the scanning or store the scanning direction in advance, based on the received user selection, thereby improving user's convenience.

According to an aspect of further example embodiment, a display apparatus is provided, including a signal processor configured to process an image signal of an video wall image, a display configured to scan in one of a first scanning direction and a second scanning direction opposite the first scanning direction based on the processed image signal to display an individual image split from the video wall image, and a controller configured to control the display to scan in one of the first scanning direction and the second scanning direction determined based on a scanning direction of an adjacent other display apparatus. Accordingly, the display apparatus may display the video wall image without generating steps due to a difference in time in which a frame is displayed on meeting portions between the adjacent display apparatuses in the video wall screen during the vertical scanning.

As described above, according to the example embodiments, there are provided a display apparatus, a video wall system having the same and a control method thereof, which can display the video wall image without generating steps due to the difference in time in which a frame is displayed on the meeting portions between the adjacent display apparatuses in the video wall screen during the vertical scanning.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example video wall system according to an example embodiment;

FIG. 2 is a block diagram illustrating an example first display apparatus of the video wall system according to an example embodiment;

FIG. 3 is a diagram illustrating an example in which each display apparatus of the video wall system according to an example embodiment scans a screen according to a determined scanning direction;

FIG. 4 is a diagram illustrating an example in which each display apparatus of the video wall system according to an example embodiment scans a screen according to a scanning direction determined based on a rotation state;

FIG. 5 is a diagram illustrating another example in which each display apparatus of the video wall system according to an example embodiment scans a screen according to a scanning direction determined based on a rotation state;

FIG. 6 is a diagram illustrating an example of information on scanning direction, which is transmitted to each display apparatus according to an example embodiment;

FIG. 7 is a diagram illustrating an example of a user interface (UI), which is provided for a user to determine a scanning direction of each display apparatus according to an example embodiment;

FIG. 8 is a flowchart illustrating an example control method of the video wall system according to an example embodiment;

FIG. 9 is a flowchart illustrating an example method in which each display apparatus of the video wall system according to an example embodiment determines a scanning direction based on a scanning direction of an adjacent other display apparatus;

FIG. 10 is a flowchart illustrating an example method in which each display apparatus of the video wall system according to an example embodiment determines a scanning direction based on a location and a direction where it is installed; and

FIG. 11 is a flowchart illustrating an example method in which each display apparatus of the video wall system according to an example embodiment scans a screen based on a pre-stored scanning direction.

### DETAILED DESCRIPTION

Hereinafter, various example embodiments will be described in greater detail with reference to accompanying drawings. Elements illustrated in the accompanying drawings are referred to in the following descriptions of the example embodiments and for clarity, like reference numerals or symbols presented in respective drawings denote like elements, which substantially perform the same functions.

In the following description, if terminologies, each of which includes such an ordinal number as ‘first’, ‘second’ and the like, are used, those terminologies are used (unless expressly specified otherwise) merely to describe various elements. The terminologies are only used for the purpose of discriminating one element from other elements. In doing so, the various elements should be non-limited by the corresponding terminologies, respectively. The terminologies used in the following description of various example embodiments are applied for explanation purpose only and not for the purpose of limiting the example embodiments as defined by the appended claims and their equivalents.

The present disclosure described below with reference to the example embodiments may be applied to a video wall system and display apparatuses comprising the video wall system. As an implementation example of the video wall system to which the present disclosure is applied, a large format display (LFD), which is installed inside or outside the building to display an image of the content, will be described by way of illustration. However, the present disclosure is not limited thereto and the video wall system according to the present disclosure may be also implemented as a digital signage or a digital information display (DID).

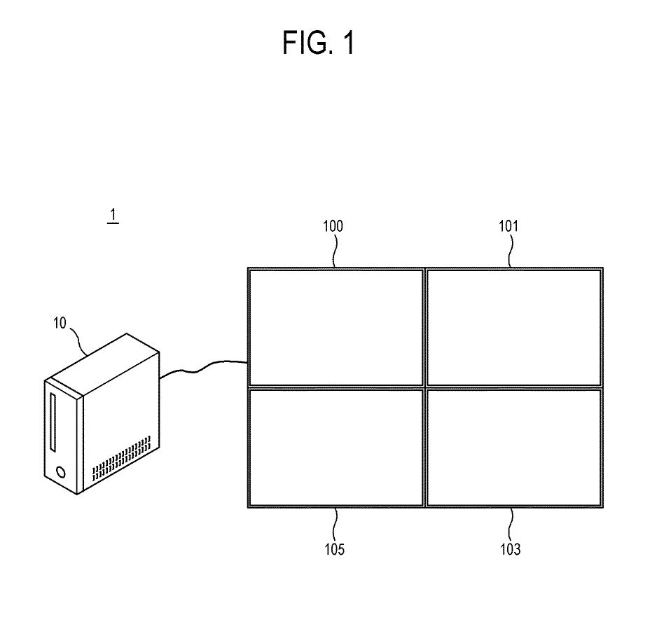

FIG. 1 is a diagram illustrating an example video wall system according to an example embodiment. The video wall system 1 includes a plurality of display apparatuses 100, 101, 103 and 105. Also, the video wall system 1 may further include an image source 10 to provide an image signal to the display apparatuses 100, 101, 103 and 105.

According to an example embodiment, the plurality of display apparatuses 100, 101, 103 and 105 comprises a video wall. The video wall in which the plurality of display apparatuses 100, 101, 103 and 105 is operated as one screen to display dividing one video wall image on the plurality of display apparatuses 100, 101, 103 and 105, scaling and displaying the one video wall image to comply with the number and arrangement of the display apparatuses 100, 101, 103 and 105. One video wall image frame is divided into regions, which correspond to the display apparatuses 100, 101, 103 and 105, respectively and the display apparatuses 100, 101, 103 and 105 displays individual image frames split from the one video wall image frame by the divided regions, respectively.

Referring to FIG. 1, as an example, the plurality of display apparatuses comprising the video wall system 1 is arranged in row and column of 2×2. In other words, two display apparatuses are arranged widthwise and two display apparatuses are arranged lengthwise. The plurality of display apparatuses, e.g., first to fourth display apparatuses 100, 101, 103, and 105 arranged in row and column of 2×2 are disposed at an upper left side, an upper right side, a lower right side, and a lower left side, respectively. Each image frame of the video wall image is divided into regions to correspond to the arrangement method of the display apparatuses 100, 101, 103 and 105, and individual image frames of the divided regions are displayed on the display apparatuses 100, 101, 103 and 105 corresponding to locations thereof, respectively. However, these are merely illustrations for the convenience of explanation, and the number and arrangement type of the display apparatuses 100, 101, 103 and 105 are not limited thereto. As above, the video wall system 1 displays the one video wall image via the plurality of display apparatuses 100, 101, 103 and 105.

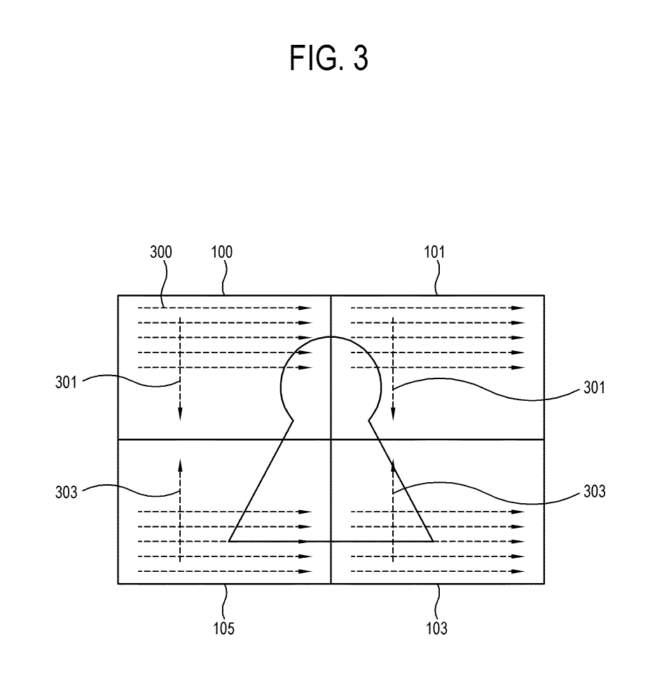

The display apparatuses 100, 101, 103 and 105 according to an example embodiment scan corresponding display panels in a predetermined scanning direction to display individual images on the corresponding display panels, respectively. The scanning includes a horizontal scanning (300 in FIG. 3), which is repeatedly performed from left to right along scanning lines of transverse directions of the display apparatuses 100, 101, 103 and 105, and a vertical scanning (301, 303, 305 and 307 in FIG. 3), which at the same time as the horizontal scanning, repeatedly moves scanning lines along longitudinal directions of the display apparatuses 100, 101, 103 and 105.

The plurality of display apparatuses 100, 101, 103, and 105 of the video wall system 1 determine vertical scanning directions based on scanning directions of adjacent other display apparatuses 100, 101, 103 and 105 to resolve steps between screens thereof, respectively. The display apparatuses 100, 101, 103, and 105 may determine scanning directions to be opposite to the scanning directions of the other display apparatuses 100, 101, 103 and 105 adjoining in scanning direction, respectively.

Hereinafter, an example in which each of the plurality of display apparatuses 100, 101, 103 and 105 determines the scanning direction based on the scanning directions of the adjacent other display apparatuses 100, 101, 103 and 105 to improve the steps will be described with reference to FIG. 3. In the following description of FIG. 3, the scanning direction is a vertical scanning direction and may simply be referred to as a scanning direction for ease of explanation, but it will be understood that the disclosure is not limited thereto. As described above, the scanning direction of each display apparatus 100, 101, 103 or 105 is determined to be opposite to the scanning direction of the other display apparatus 100, 101, 103, or 105 adjoining in the scanning direction. For example, a scanning direction of the first display apparatus 100 is determined as a first scanning direction 301 and a scanning direction of the fourth display apparatus 105 adjoining the first display apparatus 100 in scanning direction is determined as a second scanning direction 303, which is an opposite direction to the first scanning direction 301. Also, a scanning direction of the second display apparatus 101 is determined as the first scanning direction 301 and a scanning direction of the third display apparatus 103 adjoining the second display apparatus 101 in scanning direction is determined as the second scanning direction 303, which is the opposite direction thereto. As the scanning directions of the display apparatuses, for example, 100 and 105/101 and 103 adjoining in scanning direction are determined to be opposite to each other, steps, which are generated at meeting portions of the display apparatuses 100, 101, 103 and 105 operated conventionally, may be improved.

As above, the video wall system 1 according to an example embodiment perform is configured, so that the adjacent display apparatuses 100, 101, 103 and 105 perform the vertical scanning in opposite directions. Accordingly, the video wall system 1 may display the video wall image without generating steps in the video wall screen due to differences in time where the adjacent display apparatuses 100, 101, 103 and 105 start the vertical scanning, thereby improving user's convenience.

Hereinafter, a more detailed configuration of the first display apparatus 100 of the video wall system 1 according to an example embodiment will be described.

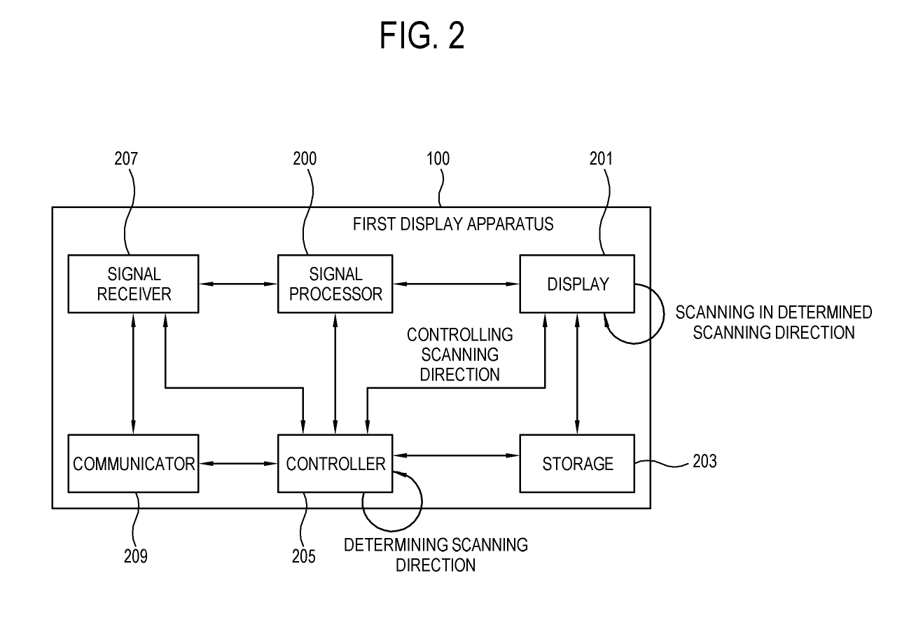

FIG. 2 is a block diagram illustrating an example of the first display apparatus of the video wall system according to an example embodiment. The first display apparatus 100 may include a signal processor (e.g., including signal processing circuitry) 200, a display 201, and a controller (e.g., including processing circuitry) 205. The first display apparatus 100 may further include at least one of a signal receiver 207, a communicator (e.g., including communication circuitry) 209 and a storage 203.

The signal receiver 207 receives an image signal from an external apparatus. The signal receiver 207 may be provided with a tuner for receiving the image signal. The tuner may receive tuning a broadcast signal of any one selected by the user from among a plurality of channels. The signal receiver 207 may also receive an image signal from an image processing apparatus, such as a set-top box, a DVD player, and a PC, a mobile apparatus, such as a smart phone, or a server via an internet, or the like, without limitation.

The storage 203 is configured to store various data including image contents of the first display apparatus 100 or the like. The storage 203 may be provided with a non-volatile memory (writable ROM), which retains data regardless of whether the first display apparatus 100 is turned on or off and which is writable to reflect changes. In other words, the storage 203 may be provided with any one of a flash memory, an EPROM and an EEPROM. The storage 203 may be further provided with a volatile memory, such as a DRAM or a SRAM, which has a reading or writing speed faster than the non-volatile memory.

The signal processor 200 may include various signal processing circuitry and performs an image processing process with respect to the image signal received via the signal receiver 207 and outputs the processed image signal to the display 201 to display an image on the display 201. The image processing process, which is performed by the signal processor 200, may include, for example, a demultiplexing to divide the input transport stream into subordinate streams, which includes an image signal, an audio signal and additional data, respectively, a de-interlacing to convert an interlace type image signal into a progressive type image signal, a scaling to change the image signal in definition, a noise reduction for enhancing image quality, a detail enhancement, a frame refresh rate conversion, etc.

Under control of the controller 205, the signal processor 200 splits the video wall image with respect to a region corresponding to the first display apparatus 100 based on a location and a rotation state of the first display apparatus 100, and thereby generates an individual image.

The display 201 displays the individual image generated by splitting the video wall image at the signal processor 200. Implemented types of the display 201 are not limited, and the display 201 may be implemented in various display methods, for example, such as liquid crystal display (LCD), plasma display panel (PDP), light-emitting diode (LED) display, organic light emitting diodes (OLED) display, surface-conduction electron-emitter, carbon nano-tube, nano-crystal display, or the like.

If the display 201 is a LCD type, the display 201 includes a LCD panel, a backlight unit to supply light to the LCD panel, a panel driving board to drive the LCD panel, etc. The display 201 may be also implemented as an OLED panel, which is a spontaneous emission element, without the backlight unit.

The display 201 may further include a scanning drive circuit and a timing controller. The scanning drive circuit scans the display panel in a predetermined scanning direction to display an image on the display panel. The timing controller synchronizes an operation timing of the scanning drive circuit. A scanning timing signal includes a gate start pulse (GSP), a gate shift clock, a gate output enable (GOE), etc.

The communicator 209 may include various communication circuitry and is configured to communicate with an external apparatus, such as an image source 10, or other display apparatuses 101, 103 and 105 of the video wall system 1. The communicator 203 is implemented in various types according to implemented types of the image source 10 or the other display apparatuses 101, 103 and 105. For example, the communicator 203 may include various circuitry, such as, for example, and without limitation, a connecting part for wired communication. The connecting part may transmit/receive signals/data based on standards, such as high definition multimedia interface (HDMI), HDMI-consumer electronics control (CEC), universal serial bus (USB), component and so on, and include more than at least one connector or terminal corresponding to the standards, respectively. The communicator 209 may communicate by wire with a plurality of servers via a wired local area network (LAN).

According to design methods of the first display apparatus 100, the communicator 209 may include various constructions besides the connecting part including the connector or terminals for wired connection. As an example, the communicator 209 may include a radio frequency (RF) circuit for transmitting and receiving a RF signal to perform a wireless communication with the image source 10 and the other display apparatuses 101, 103 and 105 and may be configured to perform communication via at least one from among wireless fidelity (Wi-Fi), Bluetooth, Zigbee, ultra-wide band (UWB), wireless USB, and near field communication (NFC).

The controller 205 may include various processing circuitry and performs controls needed for operating all the elements of the first display apparatus 100. The controller 205 may include a control program for controlling to perform the control operation as described above, a non-volatile memory in which the control program is installed, a volatile memory in which at least one of the control program is loaded, and, for example, and without limitation, at least one of a dedicated processor, microprocessor or central processing unit (CPU) for executing the loaded control program. The control program may include a program (or programs) which is implemented in the form of at least one of a BIOS, a device driver, an operating system, a firmware, a platform, and an application program (application). As an example embodiment, the application program may be installed or stored in advance in the first display apparatus 100 in manufacturing, or installed in the first display apparatus 100 based data for the application received from the outside in use. The data for the application program may be downloaded to the first display apparatus 100 from an external server, such as, for example, an application market or the like.

In the example embodiment, the controller 205 controls the signal processor 200 to split the video wall image with respect to one region corresponding to the first display apparatus 100 based on a location and a rotation state of the first display apparatus 100 and thereby to generate an individual image for the first display apparatus 100. The display apparatus 100 may determine the location and the rotation state of the first display apparatus 100 based on a received input, e.g., a user input. As another example embodiment, the first display apparatus 100 may determine the location and the rotation state of the display apparatus 100 based on information received from the external. The first display apparatus 100 may further include a sensor part for detecting at least one of the location and the rotation state of the display apparatus 100.

Also, the controller 205 may determine the scanning direction based on a scanning direction of at least one adjacent (in the scanning direction) other display apparatus 101, 103 and/or 105, and controls the display 201 to scan in the determined scanning direction. The controller 205 may determine the scanning direction to be opposite to a scanning direction of adjacent display apparatus, e.g., the fourth display apparatus 105 adjoining down the first display apparatus 100 when the first display apparatus 100 is horizontally installed.

As another example, the controller 205 may determine the scanning direction based on a location where the first display apparatus 100 is installed. For example, the first display apparatus 100 may determine the scanning direction as a first scanning direction (301 in FIG. 3) if it is determined that the installed location is in an odd row, and as a second scanning direction (303 in FIG. 3) if it is determined that the installed location is in an even row. However, the present disclosure is not limited thereto. The first display apparatus 100 may receive information on the installed location from an external, or further include a sensor part for detecting the installed location or the like.

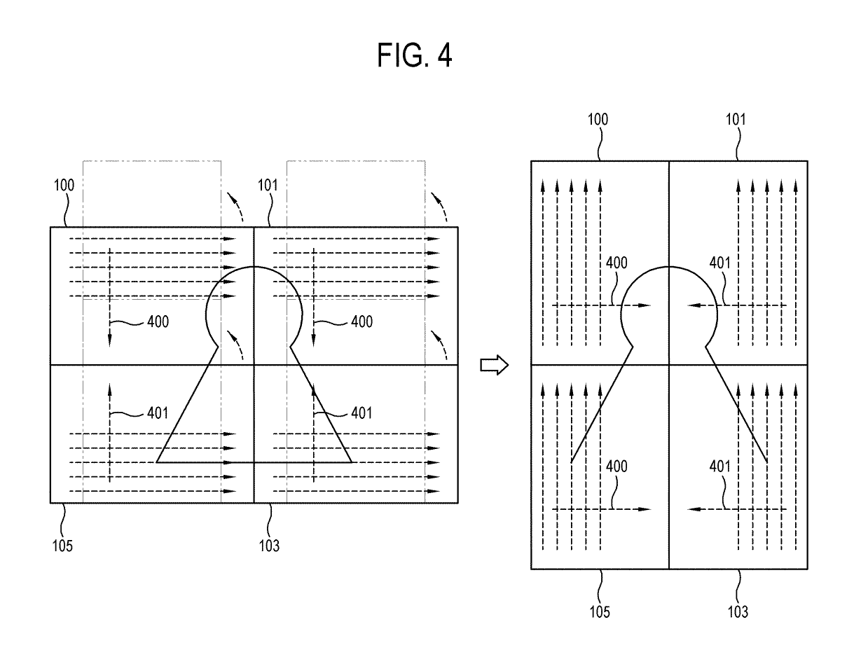

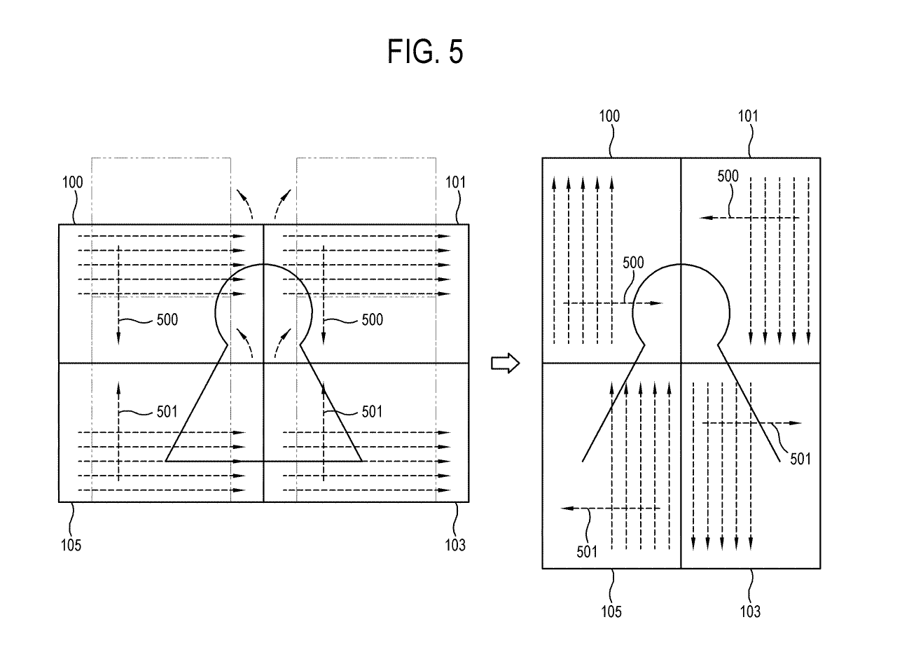

Hereinafter, an example in which the display apparatuses 100, 101, 103 and 105 of the video wall system 1 are rotated and the scanning directions of the display apparatuses 100, 101, 103 and 105 are determined based the rotation states thereof will be described with reference to FIGS. 4 and 5.

As described above, the display apparatuses 100, 101, 103 and 105 may determine the directions of screens based on the installed directions thereof. Accordingly, the display apparatuses 100, 101, 103 and 105 may determine the scanning directions based the installed directions thereof, as well as the installed locations thereof, respectively. If the display apparatuses 100, 101, 103 and 105 are rotated and installed, the directions of vertical scanning thereof are changed from left to right or from right to left. For example, if the display apparatuses 100, 101, 103 and 105 are rotated to the left so that tops thereof are located at the left side, first scanning directions 400 and 500 come to directions toward right from left, respectively. On the other hand, if the display apparatuses 100, 101, 103 and 105 are rotated to the right so that tops thereof are located at the right side, the first scanning directions 400 and 500 come to directions toward left from right, respectively.

If the scanning directions are changed from the vertical directions to the horizontal directions, the display apparatuses adjoining in scanning direction are changed from upper and lower display apparatuses 100 and 105/101 and 103 to left and right display apparatuses 100 and 101/103 and 105.

FIG. 4 is a diagram illustrating an example in which when all the plurality of display apparatuses 100, 101, 103 and 105 are rotated in the same direction, the scanning directions thereof are determined. A left drawing of FIG. 4 illustrates that before the display apparatuses 100, 101, 103 and 105 are rotated, the first display apparatus 100 and the second display apparatus 101 scan in a first scanning direction 400 and the third display apparatus 103 and the fourth display apparatus 105 scan in a second scanning direction 401, so that the display apparatuses 100 and 105/101 and 103 adjoining in vertical direction scan in opposite directions to each other.

A right drawing of FIG. 4 illustrates after the display apparatuses 100, 101, 103 and 105 are rotated to the left, respectively. Since all of tops of the display apparatuses 100, 101, 103 and 105 rotated to the left are located at the left side, the first direction 400 comes to a direction toward right from left. Since the scanning directions are changed to the horizontal directions, the first display apparatus 100 and the fourth display apparatus 105 scan in the first scanning direction 400 and the second display apparatus 101 and the third display apparatus 103 scan in a second scanning direction 401, so that the display apparatuses 100 and 101/103 and 105 adjoining in the horizontal direction are scan in opposite directions to each other. In other words, in the right drawing of FIG. 4, the first display apparatus 100 and the third display apparatus 103 maintain the scanning directions of the left drawing even after being rotated, and the second display apparatus 101 and the fourth display apparatus 105 change the scanning directions of the right drawing in reverse after being rotated. However, the idea of the present disclosure is not limited to the illustrated drawings.

FIG. 5 illustrates an example in which when a portion of the display apparatuses 100, 101, 103 and 105 is rotated in a different direction, the scanning directions thereof is determined. A left drawing of FIG. 5 illustrates that before the display apparatuses 100, 101, 103 and 105 are rotated, the first display apparatus 100 and the second display apparatus 101 scan in a first scanning direction 500 and the third display apparatus 103 and the fourth display apparatus 105 scan in a second scanning direction 501, so that the display apparatuses 100 and 105/101 and 103 adjoining in vertical direction scan in opposite directions to each other.

A right drawing of FIG. 5 illustrates after a portion of the display apparatuses 100, 101, 103 and 105 is rotated to the left and the remainder is rotated to the right. Since tops of the first and the fourth display apparatuses 100 and 105 rotated to the left are located at the left side, the first direction 500 comes to a direction toward right from left. Since tops of the second and the third display apparatuses 101 and 103 rotated to the right are located at the right side, the first direction 500 comes to a direction toward left from right.

After the rotation, both the first and the second display apparatuses 100 and 101 scan in the first scanning direction 500, but in opposite directions to each other. Similarly, both the third and the fourth display apparatuses 103 and 105 scan in the second scanning direction 501, but in opposite directions to each other. In other words, the display apparatuses 100, 101, 103 and 105 in the left drawing of FIG. 5 was rotated in such a manner that the display apparatuses 100 and 101/103 and 105 adjoining in the scanning directions, which are horizontal directions, after the rotation are rotated in opposite directions to each other, respectively. Since screens displayed on the display apparatuses 100, 101, 103 and 105 are also rotated to comply with the rotation states of the display apparatuses 100, 101, 103 and 105, the display apparatuses 100 and 101/103 and 105 adjoining in the scanning direction scan in opposite directions to each other, respectively, even if the display apparatuses 100, 101, 103 and 105 of the right drawing maintain the scanning directions of the left drawing. Accordingly, steps generating between meeting portions of the adjacent display apparatuses 100 and 101/103 and 105 may be improved. However, the idea of the present disclosure is not limited to the illustrated drawings.

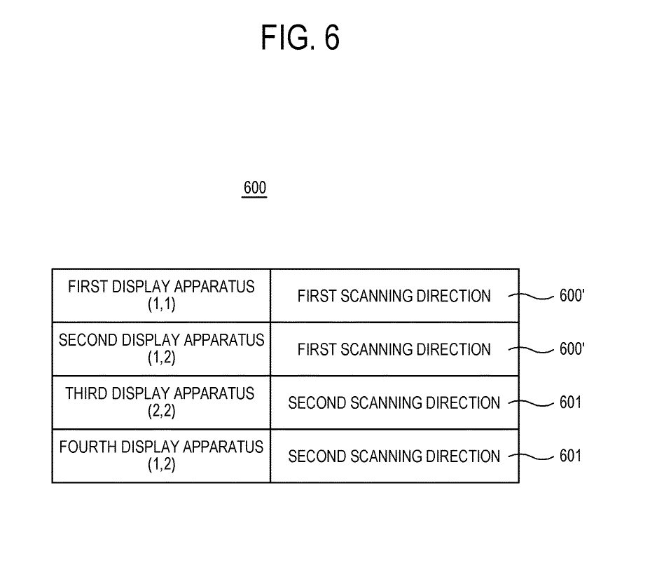

FIG. 6 illustrates an example of information on scanning direction, which is transmitted to each display apparatus according to an example embodiment. The information 600 on scanning direction includes locations and scanning directions of the display apparatuses 100, 101, 103 and 105. The display apparatuses 100, 101, 103 and 105 may determine the scanning directions, respectively, based on information 600 on scanning direction received from an external. If the display apparatuses 100, 101, 103 and 105 are implemented to be daisy-chained to one another, each display apparatus 100, 101, 103 or 105 may relay the video wall image and the information 600 on scanning direction to adjacent other display apparatus 100, 101, 103 or 105. The display apparatuses 100, 101, 103 and 105 may determine scanning directions referring to the information 600 on scanning direction, update the information 600 on scanning direction using the determined scanning directions, and transmit the updated information to next display apparatus 100, 101, 103 or 105, respectively. For example, if the plurality of display apparatuses 100, 101, 103 and 105 are horizontally installed, the first display apparatus 100 determines a first scanning direction 600′ as a scanning direction thereof, updates the information 600 on scanning direction using the determined first scanning direction and a location of the first display apparatus 100, and transmits the updated information to the second display apparatus 101. Since the second display apparatus 101 does not adjoin the first display apparatus 100 in the scanning direction, the second display apparatus 101 determines the first scanning direction 600′ as a scanning direction thereof, updates the information 600 on scanning direction, and transmits the updated information to the third display apparatus 103. Since the third display apparatus 103 adjoins the second display apparatus 101 in the scanning direction, the third display apparatus 103 determines as a scanning direction thereof, a second scanning direction 601, which is opposite to the first scanning direction 600′ determined as the scanning direction of the second display apparatus 101, updates the information 600 on scanning direction, and transmits the updated information to the fourth display apparatus 105. Since the fourth display apparatus 105 adjoins the first display apparatus 100 in the scanning direction, the fourth display apparatus 105 determines as a scanning direction thereof, the second scanning direction 601, which is opposite to the first scanning direction 600′ determined as the scanning direction of the first display apparatus 100. However, the idea of the present disclosure is not limited to the illustrated drawing and explanations as described above with respect thereto.

As another example embodiment, the information on scanning direction may be received from the external. For example, if information capable of determining respective scanning directions of the plurality of display apparatuses 100, 101, 103 and 105 is received from an external apparatus, such as an image source 10, a server or the like, the controller 205 may determine a scanning direction of the first display apparatus 100 based on the received information. In the example embodiment, the display apparatuses 100, 101, 103 and 105 may store information 600 on scanning direction received from the external apparatus, and scan in a scanning direction determined based on the stored information 600, respectively.

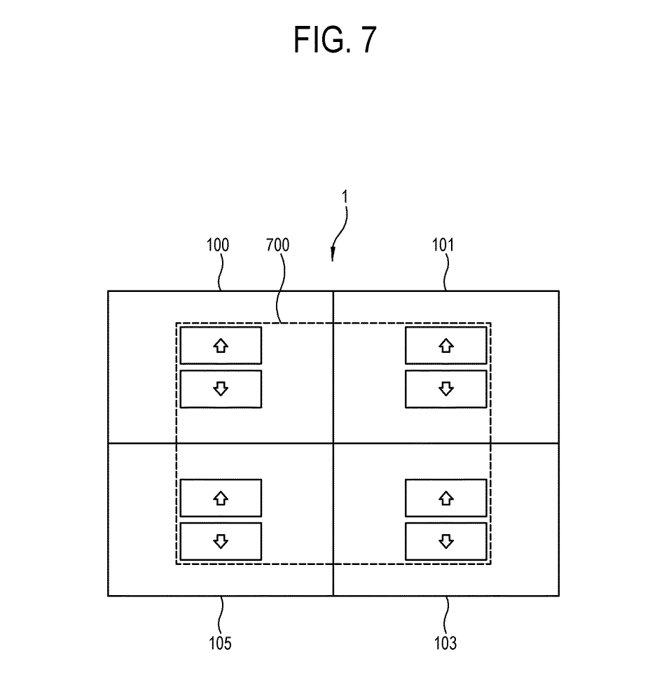

FIG. 7 is a diagram illustrating an example of a user interface (hereinafter, referred to a ‘UI’) provided for a user to determine the scanning direction of each display apparatus according to an example embodiment.

Each display apparatus 100, 101, 103 or 105 may determine the scanning direction based on a user input. For this, each display apparatus 100, 101, 103 or 105 provides the UI 700 for the user to select the scanning direction thereof. The user individually selects the respective scanning directions of the display apparatus 100, 101, 103 and 105 using the UI 700, so that the scanning directions of the adjacent display apparatuses come to be opposite to each other.

As another example, the UI 700 may be provided via the image source, the server or the like external apparatus, which controls the respective display apparatuses 100, 101, 103 and 105. The UI 700 may include items corresponding to the respective display apparatuses 100, 101, 103 and 105 and items for determining scanning directions of the respective display apparatuses 100, 101, 103 and 105, and the user may select the scanning directions of the respective display apparatuses 100, 101, 103 and 105 using the UI 700. If a user input is received via the UI 700, the external apparatus transmits information 600 on scanning direction selected by the user to the respective display apparatuses 100, 101, 103 and 105 and the respective display apparatuses 100, 101, 103 and 105 scans referring to the information 600 on scanning direction.

As described above, the video wall system 1 according to an example embodiment includes the plurality of display apparatus 100, 101, 103 and 105, each of which determines the scanning direction based on the scanning direction of the adjacent other display apparatus 100, 101, 103 or 104 and scans in the determined scanning direction to display the corresponding individual image. Accordingly, the video wall system 1 may display the video wall image without the steps caused by differences in screen playing speed between the adjacent display apparatuses.

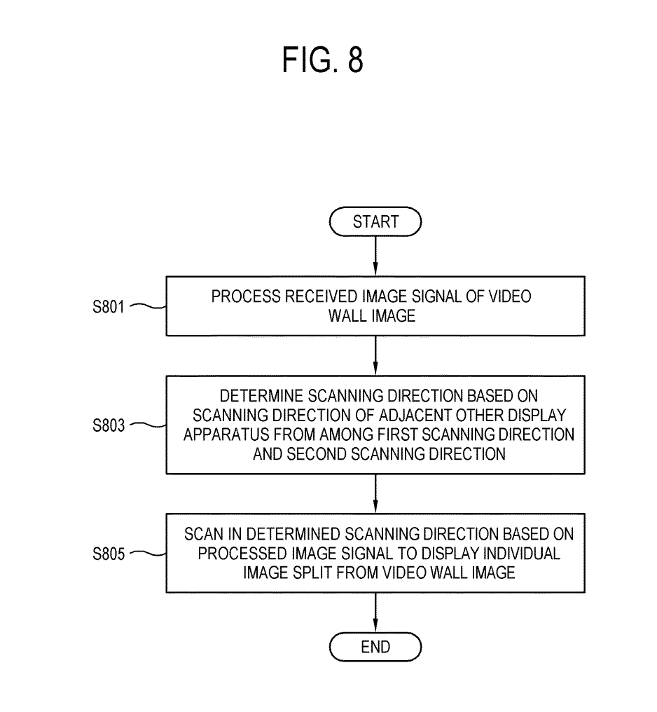

FIG. 8 is a flowchart illustrating an example control method of the video wall system according to an example embodiment.

At an operation S801, the signal receiver 207 receives an image signal of a video wall image, and the signal processor 200 processes the image signal of the video wall image received via the signal receiver 207. For example, the signal processor 200 processes the image signal, so that the video wall image is split with respect to one region corresponding to each corresponding display apparatus 100, 101, 103 or 104 according to a rotation state and a location where each corresponding display apparatus 100, 101, 103 or 104 is installed, thus to generate an individual image to be displayed on the display 201. At an operation S803, the controller 205 determines one scanning direction based on a scanning direction of an adjacent other display apparatus, from among a first scanning direction (301 in FIG. 3) and a second scanning direction (303 in FIG. 3), wherein the second scanning direction 303 is opposite to the first scanning direction 301. At an operation S805, the controller 205 may control the display 201 to scan in the determined scanning direction based on the processed image signal to display thereon the individual image generated by splitting the video wall image with respect to the one region.

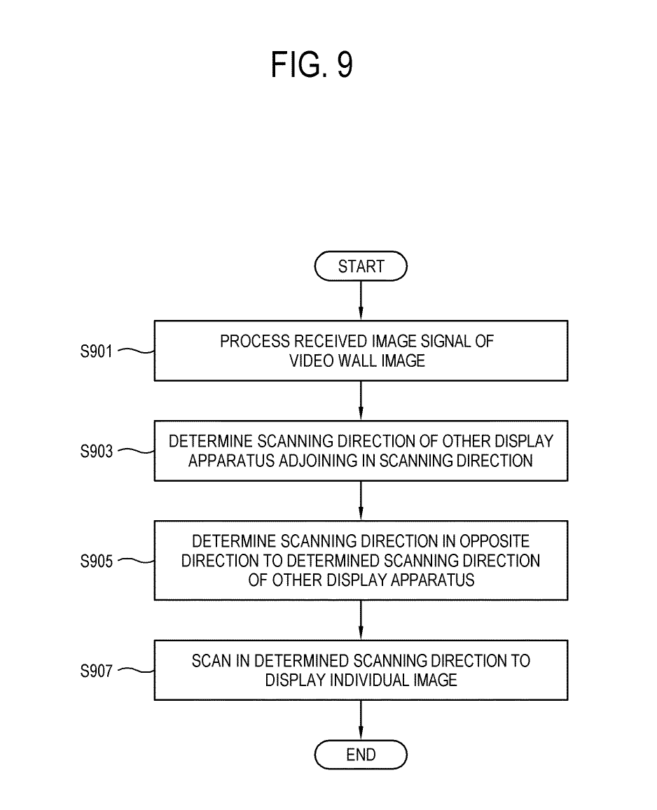

FIG. 9 is a flowchart illustrating an example method in which each display apparatus of the video wall system according to an example embodiment determines the scanning direction based on the scanning direction of adjacent other display apparatus.

At an operation S901, the signal receiver 207 receives an image signal of a video wall image, and the signal processor 200 processes the image signal of the video wall image received via the signal receiver 207. At an operation S903, the controller 205 determines a scanning direction of an other display apparatus 100, 101, 103 or 105 adjoining in the scanning direction, based on information 600 on scanning direction received from an external. At an operation S905, the controller 205 determines a scanning direction to be in a direction opposite to the determined scanning direction of the other display apparatus 100, 101, 103 or 105 adjoining in the scanning direction. At an operation S907, the controller 205 control the display 201 to scans in the determined scanning direction based on the processed image signal to display thereon an individual image generated by splitting the video wall image with respect to one region corresponding to each corresponding display apparatus.

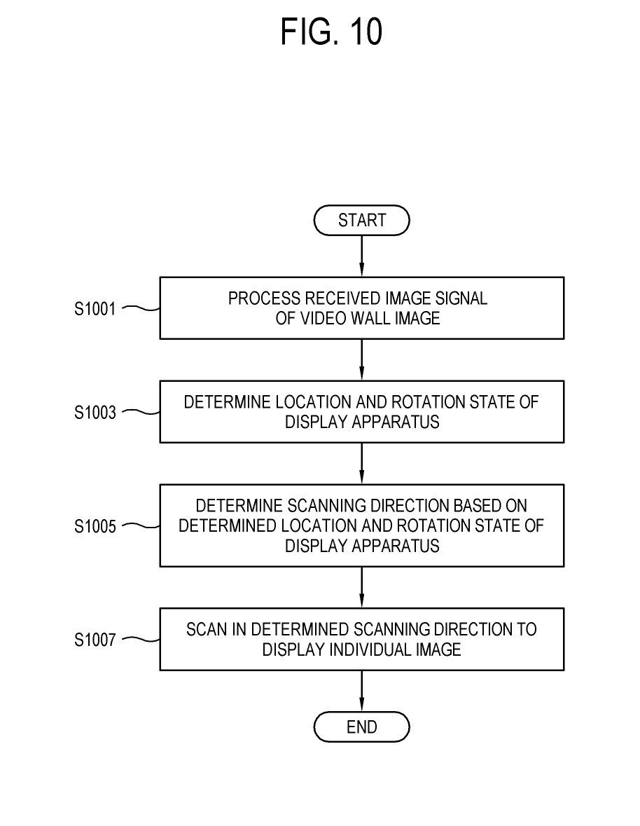

FIG. 10 is a flowchart illustrating an example method in which each display apparatus of the video wall system according to an example embodiment determines the scanning direction based on a location and a direction where it is installed. At an operation S1001, the signal receiver 207 receives an image signal of a video wall image, and the signal processor 200 processes the image signal of the video wall image received via the signal receiver 207. At an operation S1003, the controller 205 determines a rotation state and a location where each corresponding display apparatus 100, 101, 103 or 104 is installed. As an example, the installed location and the installed rotation state may be determined based on information received from an external. As another example, each corresponding display apparatus 100, 101, 103 or 104 may include a sensor part configured to detect at least one of the installed location and the installed rotation state. At an operation S1005, the controller determines a scanning direction based on the determined location and rotation state. For example, the controller 205 may determine the scanning direction to scan in an opposite direction to a scanning direction of other display apparatus 100, 101, 103 or 105 adjoining in scanning direction, according to whether each corresponding display apparatus 100, 101, 103 or 104 is horizontally installed and located in an odd row or vertically installed and located in an even row. At an operation S1007, the controller 205 control the display 201 to scan in the determined scanning direction based on the processed image signal to display thereon an individual image generated by splitting the video wall image with respect to one region corresponding to each corresponding display apparatus.

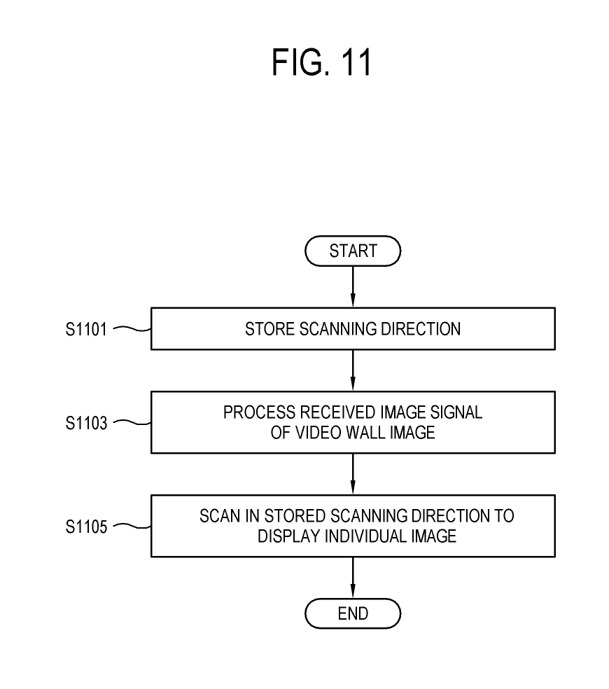

FIG. 11 is a flowchart illustrating an example method in which each display apparatus of the video wall system according to an example embodiment scans a screen based on a pre-stored scanning direction. At an operation S1101, the controller 205 stores in the storage 203, a scanning direction determined based on information 600 on scanning direction received from an external apparatus. The information 600 on scanning direction may be received from other display apparatus 100, 101, 103 or 105, as well as an external apparatus, such as an image source 10, a sever, or the like. If the information 600 on scanning direction is received, the controller 205 may determine a scanning direction based on the received information 600, update the information 600 based on the determined scanning direction depending on implementation ways, and to control the communicator 209 to transmit the updated information to next display apparatus 100, 101, 103 or 105. At an operation S1103, the signal receiver 207 receives an image signal of a video wall image, and the signal processor 200 processes the image signal of the video wall image received via the signal receiver 207. At an operation S1105, the controller 205 control the display 201 to scan in the determined scanning direction based on the processed image signal to display thereon an individual image generated by splitting the video wall image with respect to one region corresponding to each corresponding display apparatus.

While various example embodiments have been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. A video wall system comprising:
a plurality of display apparatuses configured to display a video wall image,
wherein each of the plurality of display apparatuses comprises:
a signal processor configured to process an image signal of a video wall image;
a display configured to scan in one of a first scanning direction and a second scanning direction opposite the first scanning direction based on the processed image signal to display an individual image split from the video wall image; and
a controller configured to control the display to scan in one of the first scanning direction and the second scanning direction determined based on a scanning direction of an adjacent other display apparatus.

2. The system according to claim 1, wherein the controller is configured to determine the one of the first scanning direction and the second scanning direction to be in an opposite direction to a scanning direction of the adjacent other display apparatus adjoining in scanning direction.

3. The system according to claim 1, wherein the controller is configured to determine an orientation direction of screen based on a rotation direction at which the display apparatus is installed.

4. The system according to claim 1, wherein the controller is configured to control the display to scan in one of the first scanning direction and the second scanning direction determined based on a location at which the display apparatus is installed.

5. The system according to claim 4, wherein the controller is configured to control the display to scan in one of the first scanning direction and the second scanning direction determined further based on a rotation direction at which the display apparatus is installed.

6. The system according to claim 1, further comprising:
a storage configured to store one of the first scanning direction and the second scanning direction selected based on the scanning direction of the adjacent other display apparatus,
wherein the controller is configured to control the display to scan based on the stored one scanning direction.

7. The system according to claim 6, wherein the controller is configured to store in the storage, one of the first scanning direction and the second scanning direction received from an external apparatus.

8. The system according to claim 6, wherein the controller is configured to store in the storage, one of the first scanning direction and the second scanning direction selected by a user.

9. The system according to claim 1, wherein the controller is configured to control the display to scan in one of the first scanning direction and the second scanning direction selected by a user.

10. The system according to claim 1, wherein the controller is configured to display on the display, a user interface (UI) for selecting one of the first scanning direction and the second scanning direction.

11. A control method of a video wall system comprising a plurality of display apparatuses configured to display a video wall image, the method comprising:
processing, by each of the plurality of display apparatuses, an image signal of a video wall image;
scanning, by each of the plurality of display apparatuses, in one of a first scanning direction and a second scanning direction opposite the first scanning direction based on the processed image signal to display an individual image split from the video wall image,
wherein the scanning comprises scanning in one scanning of the first scanning direction and the second scanning direction determined based on a scanning direction of an adjacent other display apparatus.

12. The control method according to claim 11, wherein the scanning comprises determining the one of the first scanning direction and the second scanning direction to be in an opposite direction to a scanning direction of the adjacent other display apparatus adjoining in scanning direction.

13. The control method according to claim 11, wherein the individual image is displayed to have an orientation direction of screen determined based on a rotation direction in which the display apparatus is installed.

14. The control method according to claim 11, wherein the scanning comprises scanning in one of the first scanning direction and the second scanning direction determined based on a location at which the display apparatus is installed.

15. The control method according to claim 14, wherein the scanning comprises scanning in one of the first scanning direction and the second scanning direction determined further based on a rotation direction at which the display apparatus is installed.

16. The control method according to claim 11, wherein the scanning comprises:
storing one of the first scanning direction and the second scanning direction selected based on the scanning direction of the adjacent other display apparatus; and
scanning based on the stored one scanning direction.

17. The control method according to claim 16, wherein the storing comprises storing one of the first scanning direction and the second scanning direction received from an external apparatus.

18. The control method according to claim 16, wherein the storing comprises storing one of the first scanning direction and the second scanning direction selected by a user.

19. The control method according to claim 11, wherein the scanning comprises scanning in one of the first scanning direction and the second scanning direction selected by a user.

20. A display apparatus comprising:
a signal processor configured to process an image signal of a video wall image;
a display configured to scan in one of a first scanning direction and a second scanning direction opposite the first scanning direction based on the processed image signal to display an individual image split from the video wall image; and
a controller configured to control the display to scan in one of the first scanning direction and the second scanning direction determined based on a scanning direction of an adjacent other display apparatus.
